(19) United States
(12) Patent Application Publication
(10) Pub. No.: US 2007/0260375 A1
(43) Pub. Date: Nov. 8, 2007

(54) Real-time vehicle management and monitoring system

(76) Inventor: Blaine Hilton, Portage, IN (US)

Correspondence Address: CHERSKOV & FLAYNIK;LAWYERS, THE CIVIC OPERA BUILDING, 20 NORTH WACKER DRIVE, CHICAGO, IL, 60606, US

(21) Appl. No.: 11/787,106

(22) Filed: Apr. 12, 2007

Related U.S. Application Data
(60) Provisional application No. 60/791,933, filed on Apr. 12, 2006.

(51) Int. Cl. G01M 17/007

(52) U.S. Cl. 701/35

(57) ABSTRACT

Embodiments relate to a real-time vehicle management and monitoring system and method. The system comprises at least a vehicle subsystem, a control subsystem, a dispatch subsystem, a maintenance subsystem, and a rider subsystem. As illustrated, the vehicle subsystem comprises a vehicle, a production tracking device, a global positioning system device, a rain gauge device, a steering wheel sensor device, at least one camera, at least one display; and an engine diagnostic system. The system further comprises the control subsystem communicating (wirelessly for example) with at least the vehicle system, the dispatch subsystem, the maintenance subsystem and the rider subsystem.

### PRIORITY INFORMATION

This application claims the benefit of provisional patent application No. 60/791,933 filed on Apr. 12, 2006.

### BACKGROUND OF THE INVENTION

1. Field of the Invention

Embodiments relate to a system and method for managing and monitoring vehicles. In particular, embodiments relate to a system and method for managing and monitoring vehicles using real-time data gathered from a variety of novel sensors. Further, the system monitors the health and well being of the driver and occupants of the vehicle in real-time.

2. Background of the Invention

Vehicles employ various systems (starter systems, battery systems, charging systems, braking systems, and cooling systems) in addition to requiring operators or drivers. Degradation of one or more of the vehicle subsystems, or incapacitation of the operator or driver may result in the unsafe operation of the vehicle.

Various techniques have been employed in the past to monitor particular components of the powered vehicle. Unfortunately, translation and interpretation of the results of the techniques is always left to a mechanic, or other person, to analyze the problem and make a recommendation as to repair. Furthermore, such monitor-type systems generally provide only “after the fact” information.

Several current patents disclose methods of monitoring vehicle performance, but these patents employ older approaches to vehicle tracking. One such previous approach is discussed in U.S. Pat. No. 6,629,029. There, the status of the vehicle is monitored through factory-installed sensors. The sensor data is downloaded into a plug-in device that monitors current vehicle condition. Once the data is gathered, it can be accessed from the device and downloaded to a central software server. The plug-in module in that patent could provide past driving information only when the module was interfaced with the central repository.

A different approach is embodied in patents such as U.S. Pat. No. 6,285,953. The vehicle management system disclosed by the '953 patent may convey real-time GPS positions of the vehicle. However, the '953 patent does not relate any additional information about the vehicle beyond the vehicle's position.

There is a need for system and method that provides for real-time monitoring and management of one or more vehicles. The system would not be relegated to displaying warnings based on past driving behavior. The system should also utilize sensors other than those factory installed. Thus the system should not require access to a factory-installed communications bus. The system should also allow the main system operator to determine the status of the vehicle driver through the use of additional sensors such as those embedded in a steering wheel.

### SUMMARY OF THE INVENTION

An object of the invention is to provide a system and method useful in tracking and managing one or more vehicles (in real-time for example) that overcomes several of the disadvantages of the prior art.

Another object of the present invention is to provide a system to monitor a vehicle and vehicle operator in real time. A feature of the invention is the use of vehicle location technology in conjunction with an array of sensors to determine the current location of the vehicle, the current mechanical status of the vehicle, and the physiological status of the driver of the vehicle. An advantage of the invention is that such determinations are made in real time.

Still another object of the present invention is to provide a vehicle management and monitoring system and method. Features of the invention include the real time communication and reaction of the system based on commands received from a control subsystem, a dispatch subsystem, a maintenance subsystem, a user subsystem, those commands the result of data received from a global positioning system device, a rain gauge device, a steering wheel sensor device, at least one camera, at least one display; and an engine diagnostic system. An advantage of the system is that the subsystems communicate (wirelessly for example) with each other, and without the need for a factor-authorized database or data repository.

Other embodiments relate to a system and method for detecting issues related to the safety and well being of the vehicle operator.

Yet other embodiments relate to a system and method for bringing a vehicle to a controlled stop upon driver failure.

Another embodiment relates to a system and method for detecting, recording, and reporting school bus stop arm violations.

### DESCRIPTION OF THE DRAWING

Embodiments together with the above and other objects and advantages may best be understood from the following detailed description of the embodiments illustrated in the drawings, wherein:

FIG. 1 depicts a block diagram of an overview of the invented system in accordance with features of the present invention;

FIG. 2 depicts a block diagram of the system of FIG. 1 in accordance with features of the present invention;

FIG. 3 depicts a schematic representation of an overview of a system, a real-time vehicle management and monitoring system for example, in accordance with features of the present invention;

FIG. 4 depicts a block diagram of the vehicle control subsystem of FIG. 3, in accordance with features of the present invention;

FIG. 5 depicts a schematic representation of an overview of the communication between the various subsystems, in accordance with features of the present invention;

FIG. 6 depicts a high level flow diagram illustrating embedded software flow in the system of FIG. 3, in accordance with features of the present invention;

FIG. 7 depicts a schematic representation of a vehicle used with the system depicted in FIG. 3, in accordance with features of the present invention;

FIG. 8 depicts a schematic representation of vehicle driver detail using the vehicle depicted in FIG. 7, in accordance with features of the present invention;

FIG. 9A depicts a steering wheel sensor arrangement used with the vehicle depicted in FIG. 7, in accordance with features of the present invention;

FIG. 9B is a schematic diagram of a steering wheel sensor, in accordance with features of the present invention;

FIG. 10 depicts a method for detecting a stop arm violation using the vehicle depicted in FIG. 7, in accordance with features of the present invention;

FIG. 11 depicts a high level flow diagram illustrating a method of undertaking a controlled vehicle stop, in accordance with features of the present invention;

FIG. 12 is a schematic showing the details of the input/output expansion capabilities of the production tracker and how these interface to the microcontroller found within the production tracker, in accordance with features of the present invention;

FIG. 13 is a schematic representation of the microcontroller area of the production tracker circuit, in accordance with features of the present invention; and

FIG. 14 is a schematic showing the details of the power supply section of the production tracker circuitry, in accordance with features of the present invention.

### DETAILED DESCRIPTION OF THE INVENTION

### Production Tracker

An integral part of the system is a device called a “production tracker.” The device is ideally suited for any of a wide range of production tracking tasks. It is contemplated that a production tracker may be placed at each worksite in a company and various attachments such as sensors, communication busses, displays, and indicators may connected thereto.

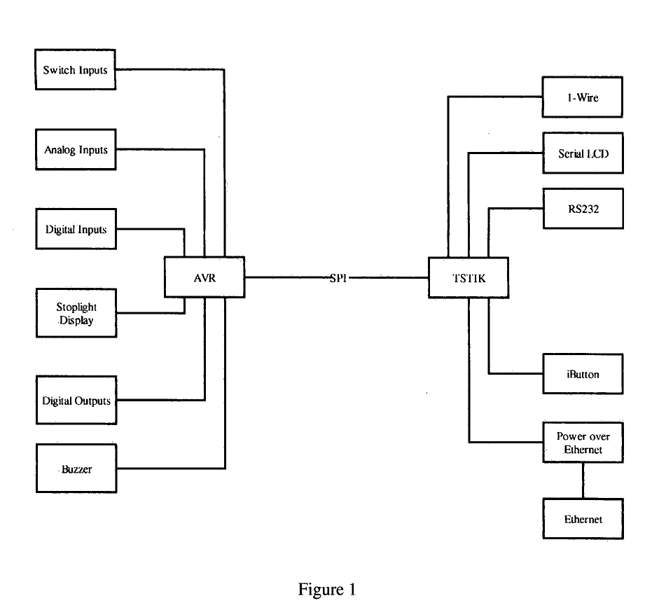

FIG. 1 shows a schematic depiction of a production tracker. The outside environment interacts with the production tracker through switches, as well as analog to and digital inputs. The inputs are processed by a commercially available data processor or a plurality of microcontrollers widely available. FIG. 1 depicts one such plurality of microcontrollers, the “AVR” commercially available from Atmel, a publicly traded company in San Jose, Calif.

In one embodiment, shown in FIG. 1, the production tracker interconnects the AVR with the processing “TSTIK” facility. TSTIK is a commercially available digital controller sold by Systronix Corporation of Salt Lake City, Utah. Additionally, as indicated by FIG. 1, the AVR and TSTIK controllers are interconnected by a serial interface, such as the “Serial Peripheral Interface Bus” (SPI), depicted in FIG. 1.

In at least one embodiment, the production tracker itself is connected to a central server (through an Ethernet based TCP/IP network for example) which manages the device. The server allows for information to be retrieved by accessing it through a web based interface from any computer with a current web browser.

The production trackers may be programmed in an easy to use web based environment creating a set of measurements for each production tracker to as “profiles”. These profiles are saved on the system and may be easily duplicated to other production trackers or modified, especially in circumstances where short runs are necessary.

It is contemplated that the production tracker is one component of a larger system (See FIG. 3 for example). Each workstation in a company would have this device. Upon starting work at a station, an employee inserts his key or identification device, referred to as an iButton in FIG. 1. A myriad of identification devices are commercially available, such as those made by Maxim Integrated Products, a publicly traded company based in Sunnyvale, Calif.

The tracker, connected through the network to the server, records the time the employee inserts the iButton device. The employee proceeds to work and, after every operation, pushes a button on the tracker. Each buttonpress is recorded on the server in real time. In at least one embodiment, the tracker includes at least a stop light is display integrated therein, providing real-time feed back to the user as to how well he is working.

As one embodiment in FIG. 1 shows, the tracker contains a “stoplight display.” The Red-Yellow-Green colors would be set using the pre-created profiles with thresholds to determine what values would cause which color to display. Red would indicate a problem, yellow would be a less severe notification of a warning, while green would indicate to the employee that the process is being completed within acceptable parameters.

In at least one embodiment, the production tracker device may be used with one or more vehicles (in a fleet for example). It should be appreciated that vehicles referred to in this application include ships, locomotives, aircraft of all types, and automotive vehicles such as cars, trucks and buses. With the addition of some ruggedized power input circuitry and a carrier system allowing for a variety of remote communication methods the production tracker may be used with any type of vehicle, a school bus for example.

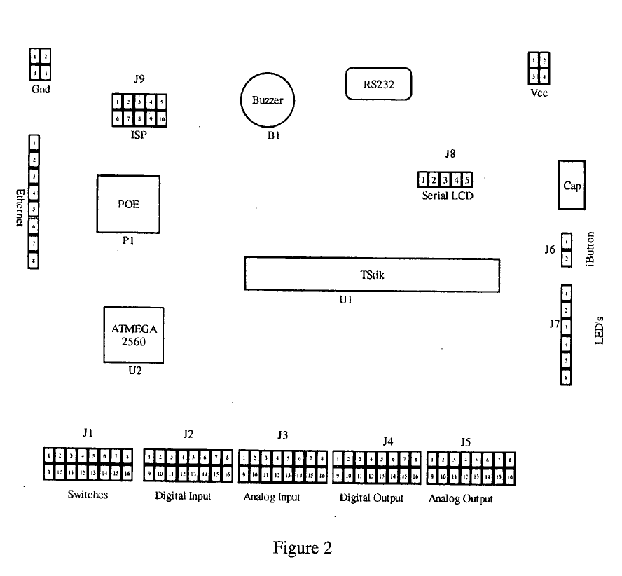

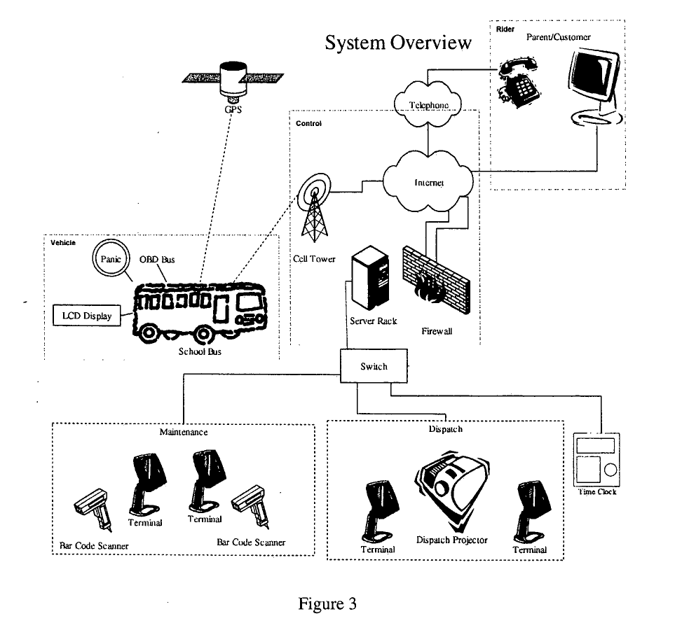

FIG. 2 depicts a printed circuit board layout diagram for the production tracker of FIG. 1 in accordance with one embodiment of the invention. FIG. 2 is a block diagram of a layout of the PCB.

ATMEGA is the commercially-available AVR depicted in FIG. 1. POE refers to the Power Over Ethernet energy supplier to the circuit board. POE is one method of powering the circuit board. The POE would eliminate having to run additional power cabling or use traditional “brick” power supplies, but it does also allow for standard low voltage AC/DC input.

FIG. 3 depicts a schematic representation of an overview of a system, a real-time vehicle management and monitoring system for example. The illustrated system comprises at least a vehicle subsystem, a control subsystem, a dispatch subsystem, a maintenance subsystem, and a rider subsystem. As illustrated, the vehicle subsystem comprises a vehicle, and a plurality of sensor and other devices. Also depicted in FIG. 3 pictured is a positioning receiver, a cellular radio receiver, an onboard diagnostics bus interface, and a LCD display. However other devices may include a production tracker device, a rain gauge device, a steering wheel sensor device, at least one camera, at least one display; and an engine diagnostic system.

Per FIG. 3, the system further comprises the control subsystem communicating (wirelessly for example) with at least the vehicle system, the dispatch subsystem, the maintenance subsystem and the school bus rider remote access subsystem.

At least one embodiment of the school bus rider remote access subsystem comprises a web base interface, a phone interface, rider notification, and/or anti-idling. Using the web based interface, a student and/or guardian who has the proper credentials (such as username and password) can access the school system's web site and find out estimated time of arrival of the vehicle, along with being able to notify the system that the rider will not be attending either for a single day or for other time period. In addition other activities such as requests to ride a different bus can be handled efficiently online.

For riders who do not have easy access to a computer with Internet access (and more specifically the World Wide Web) a phone interface may be used. The phone interface would work in much the same way as the web based interface but will be driven by a series of phone prompts. Specifically, a call would be placed to a bus system phone line. The phone line could be a VoIP based system for example, where the call would be routed over the Internet to the PBX system at the vehicle company. The Linux PBX system Asterisk, integrated to the system, facilitates transfer of information. Additionally the PBX recognizes the caller identification information to assist in supplying information in a quick manner.

Embodiments are contemplated, wherein instead of waiting for a rider to call the system, the system would allow for the system to notify the riders. It should be appreciated that this system is configurable, so as to allow different school systems and/or transit contractors to handle notification differently. The system would allow some schools to automatically call all the known riders on the bus when ever a bus is running ten or more minutes late. The call can be configured, as well as the threshold for when to make a call. In addition these calls can be stopped by the rider or guardian making a request through the system. Another feature, especially applicable in the transportation of special needs riders, comprises notification. For example, a rider's guardian or care taker is notified when a vehicle is approaching a stop. Again this helps the transition of the rider while also assigning the individual bus driver as well as the entire bus system by improving efficiencies.

The vehicle subsystem can further monitor when a vehicle's engine is running, but the vehicle itself is stopped. The system alerts the driver, in addition to keeping reports for various governmental agencies, such as the Environmental Protection Agency, to gauge compliance. Further, complied reports can be generated and managerial notifications would also be streamlined.

It should be appreciated that embodiments of the system provide many benefits. Dispatchers can visually determine vehicle position. A central projector may be used to view all vehicles on a map projected on a wall for example. In addition, software allows dispatchers to determine what bus is closest to a specific location and provide alerting to alarm conditions. The map may be zoomed in and a specific vehicle tracked as it moves in real time. Route information can also pinpoint the stops that the vehicle will make. By recording the times the stops are made, it is possible for the system to estimate time of arrivals between stops. This information can then be relayed to users, riders customers and parents. No longer will dispatchers be required to radio drivers to determine their locations. Preventing needless radio communication with the driver will help increase their concentration on the road thus improving overall safety.

In at least one embodiment, the dispatchers are the not the only ones who benefit. “Virtual PBX” are established where users (parents for example) call into the system and, using a caller ID to verify who they are, the system can provide information about the rider's (the student for example) bus and it's status, such as “The bus is on the route and should be at your stop in 8-10 minutes,” or other such audio notifications. In addition, a user can call to report their child will not be riding so a needless stop can be avoided.

Parents are not the only ones that can use the system. School systems can log into a password-protected site and see the status of the busses assigned to their needs, specifically when a school system would utilize the services of a 3^{rd} party transit contractor.

It should be appreciated that one or more embodiments of the system would provide for fuel savings. Vehicles would no longer have to stop at as many locations and wait for a rider only to find out that the rider will not be on the vehicle that day. For example, radio identification tags sown into a rider's id badge will advise a bus driver as to the likelihood of a rider being at his assigned stop, and if not, will obviate the need for the driver to visit that stop. This leads not only to an increase in fuel savings, but also to a decrease in ride time, providing for overall system efficiencies.

Embodiments may include a panic button tied into other vehicle systems. This could include an external trouble indicator such as flashing all lights. In addition, embodiments may provide for dealing with an incapacitated driver. Another feature is the ability to automatically call parents when child is dropped off. The position of a vehicle, using GPS location, is continuously relayed to the system.

If the driver of the vehicle were to have any type of event where they could no longer control the vehicle, embodiments of the system would cause the vehicle to come to a controlled stop. This would primarily occur under two circumstances: the driver was fatigued and drifted off into sleep, or the driver experienced a medical emergency, such as a heart attack.

The system monitors various points, such as speed and rate of acceleration through a plurality of sensors. This information is measured against a pre-defined set of acceptable ranges. If the sensors detect a value beyond the threshold value, alarm notifications may go off warning the driver and/or the supervisor. This information leads to increased self control, in addition to notifying management that intervention may be required.

If should be appreciated that bad driving is not just a condition caused by the driver alone, but may be tied into traffic conditions. If a specific route has continuing problems, this may be used to determine if the route itself may warrant being changed.

Additionally, embodiments allow for notification, specifically where the guardian of a rider would like to know the rider's status or a person waiting for a package would like to know delivery status and estimated time of arrival. The system may be used to automatically notify guardian(s) when the rider is let off the vehicle at the proper stop, or recipients that a package is about to be delivered.

The notifications can be sent either through a standard phone call or by sending an email. Further, the email may be configured to send an email to a properly formatted address, or send a SMS text message to the guardian(s) or designee(s) cellular phone.

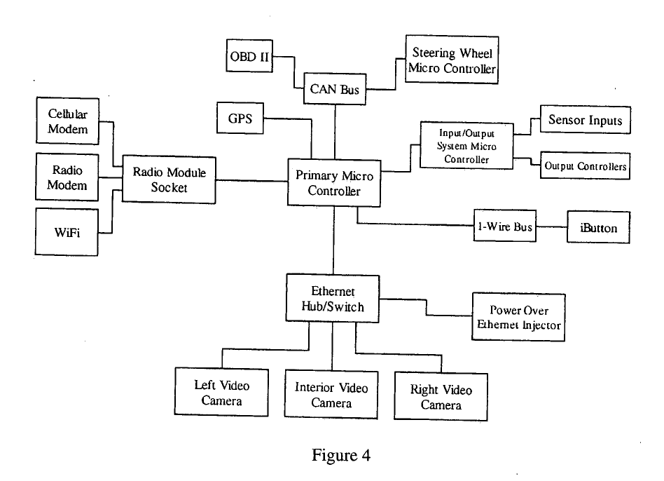

FIG. 4 depicts a block diagram of the vehicle control subsystem of FIG. 3 in accordance with one embodiment. In one or more embodiments, the vehicle subsystem includes a production tracker connected to the on-board diagnostic (OBD II) port to provide remote diagnostic capability. Any information that is so retrieved from an OBD II scanner is forwarded to the control subsystem and accessed remotely. Additionally error conditions are automatically relayed to the appropriate maintenance subsystem. This provides early warning allowing a small problem to be fixed before it becomes a larger and more costly one.

The tracker and system can include a complete maintenance management program. This can be tied into the actual trackers on the vehicles, allowing for predicative maintenance based on actual mileage that is automatically reported by the system. In addition, this can also be tied into the part tracking as well as the remote diagnostic features.

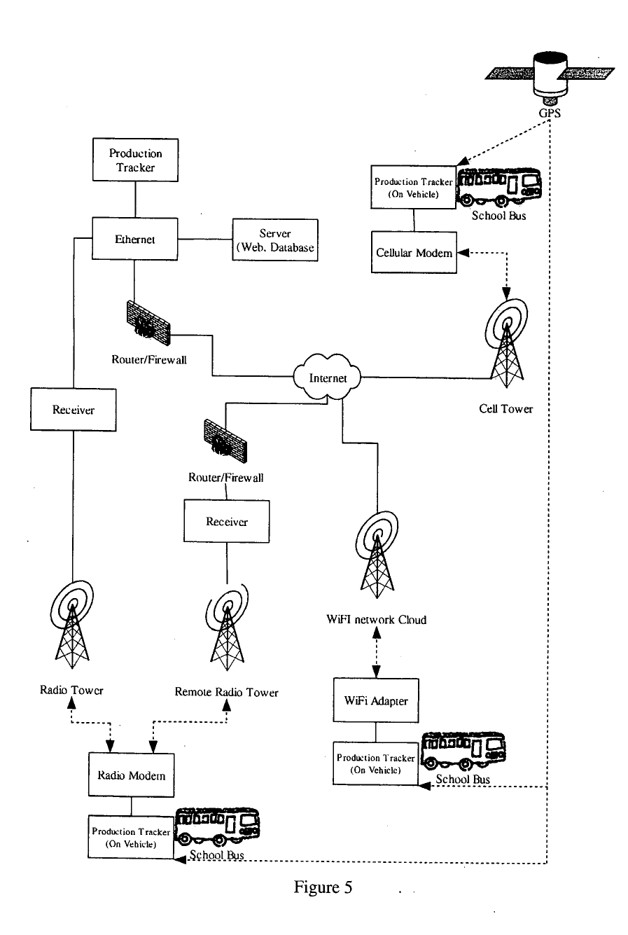

FIG. 5 depicts a schematic representation of an overview of the communication between the various subsystems in accordance with one embodiment. In the communication process, each vehicle is equipped with a Production Tracker. The Production Tracker forms the interface with the vehicle subsystem. Each vehicle subsystem also includes a global positioning receiver. As is depicted in FIG. 5, as part of the vehicle subsystem, each Production Tracker can feature a different type of communications interface. The vehicle subsystem may use a local wireless network. Alternatively, the vehicle subsystem may use a radio modem to communicate in areas where wireless networks are not available.

As FIG. 5 depicts, in addition to the production trackers in vehicles, production trackers may be installed in the maintenance area, allowing for computerized part tracking. This will allow not only complete inventory information to be available at all times, but will also help ensure that parts that having a long lead time are adequately stocked.

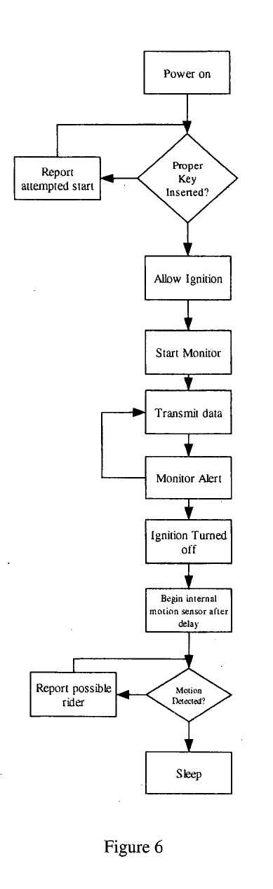

FIG. 6 is a high-level flow diagram of the vehicle subsystem software. The software processes are used within the vehicle control subsystem during the operation of the vehicle.

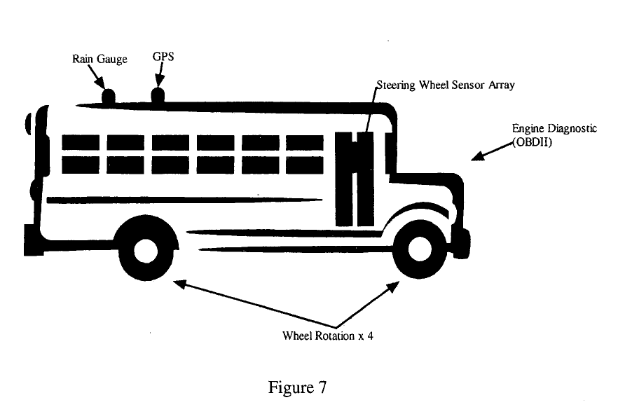

FIG. 7 is a schematic depiction of a vehicle that can be used with the system depicted in FIG. 3.

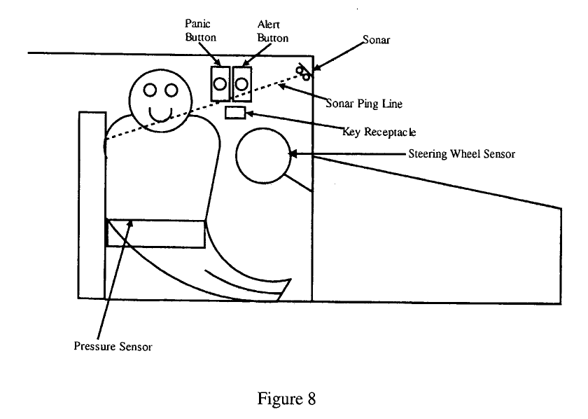

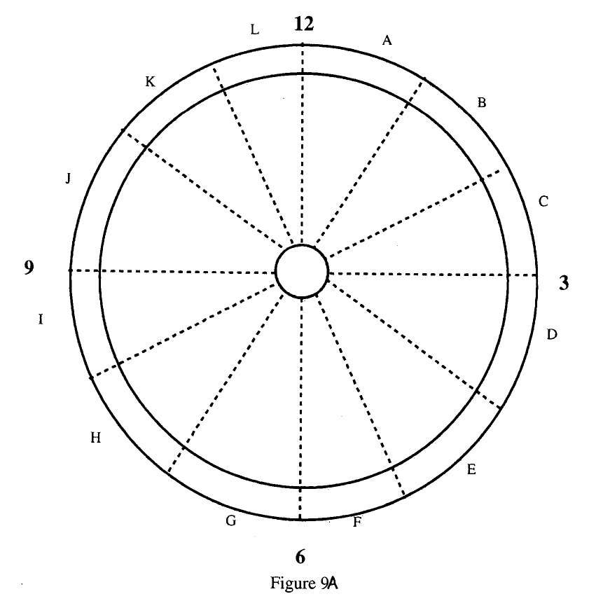

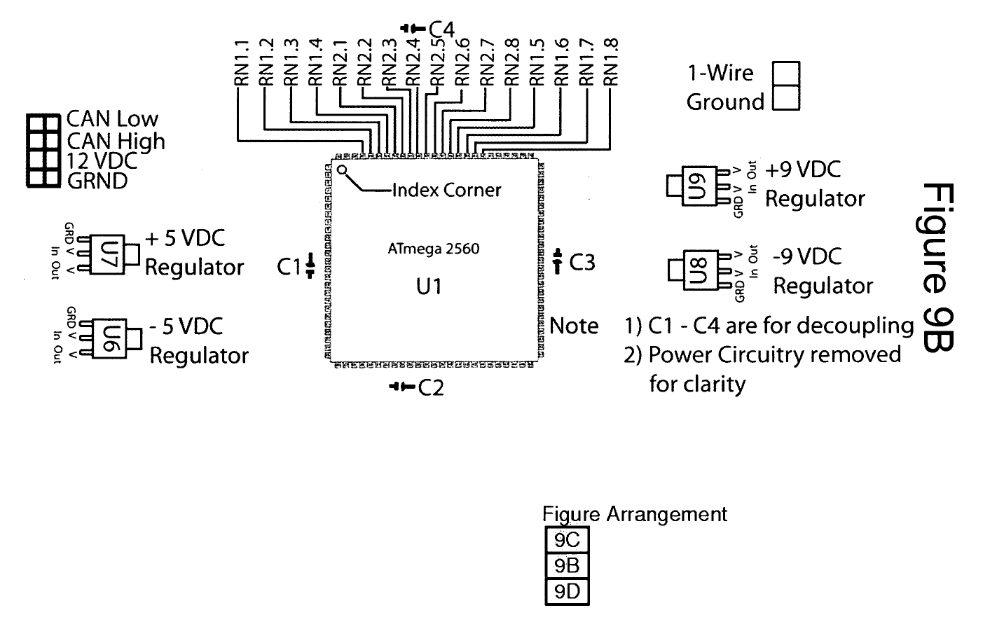

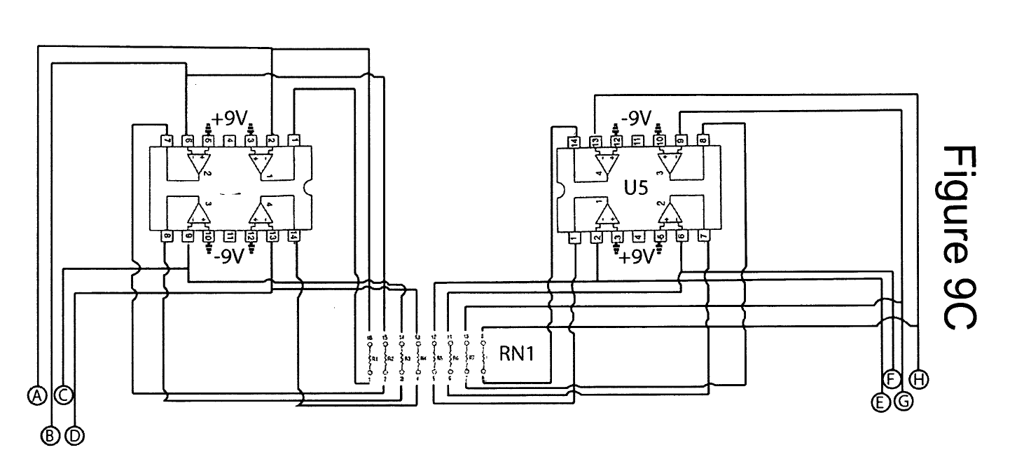

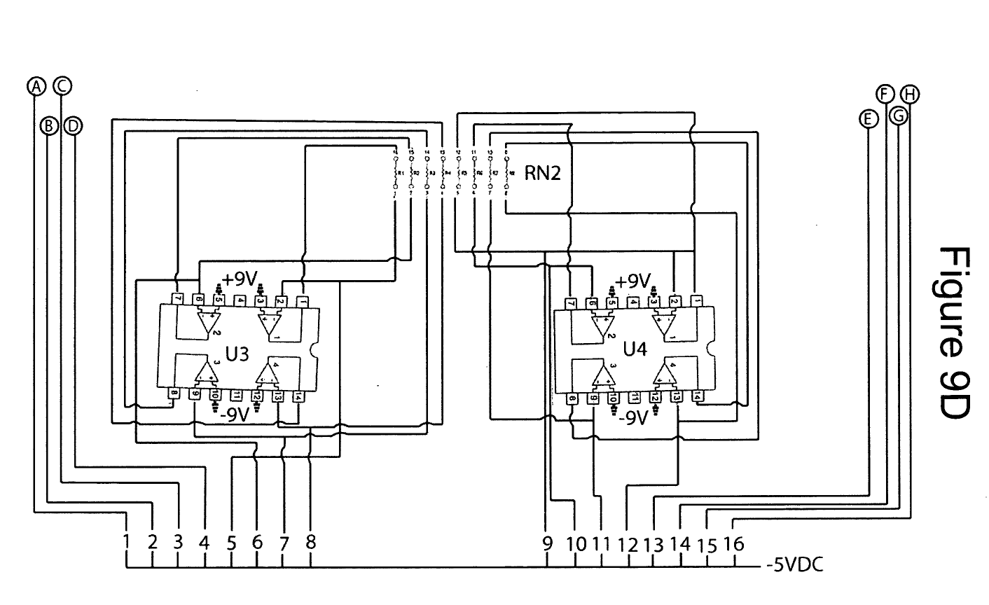

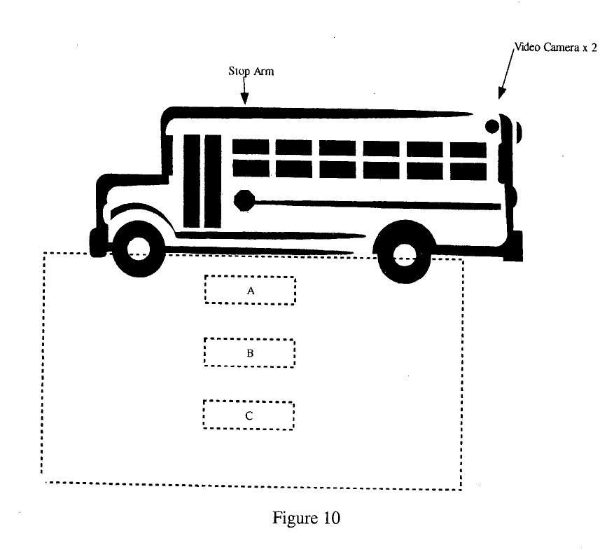

FIG. 8 shows vehicle operator detail used with the vehicle depicted in FIG. 7 in accordance with one embodiment. In the illustrated embodiment, a sonar detects the presence of the driver in an upright position. In the event of a medical emergency the driver may remain seated, but may be slumped over. In another embodiment, the sonar sensor may be mounted to a microcontroller controlled tilting mechanism and adjusted to each driver. Once a driver is enrolled into the system and inserts their key into the receptacle, the sonar will adjust to the correct position. This avoids problems associated with drivers of various heights using the same vehicle.

Further, pursuant to the embodiment shown in FIG. 8, the status of the vehicle operator is monitored by the vehicle subsystem by a pressure sensor and a steering wheel sensor. The operator can use the depicted Panic Button and Alert Button to interact with the vehicle subsystem. The operator's actions and the operator's status is conveyed by the vehicle subsystem to the control subsystem. If the control subsystem determines that the operator is incapacitated, the control subsystem can undertake an orderly stop of the vehicle. Prior to stopping the vehicle, the control system can afford the operator an opportunity to either positively confirm that the vehicle should be stopped (through depressing the Panic button depicted in FIG. 8) or to indicate to the control system that no emergency exists by depressing another button (such as the Alert button depicted in FIG. 8).

FIG. 9 depicts a steering wheel sensor arrangement used with the vehicle depicted in FIG. 7. The steering wheel sensor can be integrated into the steering wheel during the manufacture of the steering wheel, or it may be superimposed over a pre-existing steering wheel. A common installation scenario is the attachment of the sensors to the inside of commercially available steering wheel covers. This attachment can be done in the factory and then be easily applied on the vehicle while causing minimal down time of the vehicle. Depending on different makes of steering wheels, multiple sizes and attachment methods are contemplated. Also as different types of vehicles may feature different types of steering wheels, the steering wheel sensor can be adapted to best fit other shapes, as well.

In the illustrated embodiment found in FIG. 9A-B, the steering wheel is broken up into a plurality of segments (twelve segments for example, analogous to the face of a clock). Each segment is characterized by a letter, number or other symbolic designation. The letters A through L are depicted in FIG. 9A. Each area contains a plurality of sensors including a force sensor, and temperature sensor.

FIG. 9B is a schematic diagram for the steering wheel sensor. It is also contemplated that other sensors may be employed, including sensors to detect and measure the driver's pulse, blood pressure, skin moisture, etc. The sensors are connected to a small microcontroller which will in turn be connected to the primary circuitry of the vehicle subsystem. Capacitors C1-C4 flanking all sides of the microprocessor U1, are utilized for decoupling. It should be noted that the power circuitry of the steering wheel schematic has been removed for greater clarity. The bottom of the schematic provides 16 connections, to enable electrical communication for up to 16 sensors. However, sensor subassemblies can be added to each of the connections to enable connection of up to 16×16 sensors. The controller area network (CAN), a low speed serial buss, allows connection between the sensor subassembly and the primary production tracker. Alternatively, it may connect to a vehicle control area network.

Resistor Networks are designated by RN 1.1, 1.2, etc., corresponding to resister network 1, pin 1, resistor network 1, pin 2, etc.

As shown in FIG. 10, further embodiments of the vehicle subsystem include one or a plurality of video cameras mounted on the school bus. In one embodiment, the cameras record instances wherein another vehicle fails to observe the deployed stop arm. As the school bus travels on roads containing various numbers of lanes, there may be multiple zones where the video camera needs to be focused such that the camera can properly record a stop arm violator. In FIG. 10 these areas are depicted as zones A, B, and C. The angle of the video camera would be adjusted by the vehicle subsystem as the vehicle subsystem based on the number of lanes in the road. The vehicle subsystem includes the means to determine the location of the vehicle as the vehicle subsystem includes a GPS location device. The vehicle subsystem provides the video to the control subsystem which then relays it to the dispatch database. It is envisioned that the video can be used as evidence in traffic court against vehicle operators who ignore deployed stop arms. Additionally, depending on local laws it would be possible that the proceeds of these fines could be used to subsidize the cost of the system.

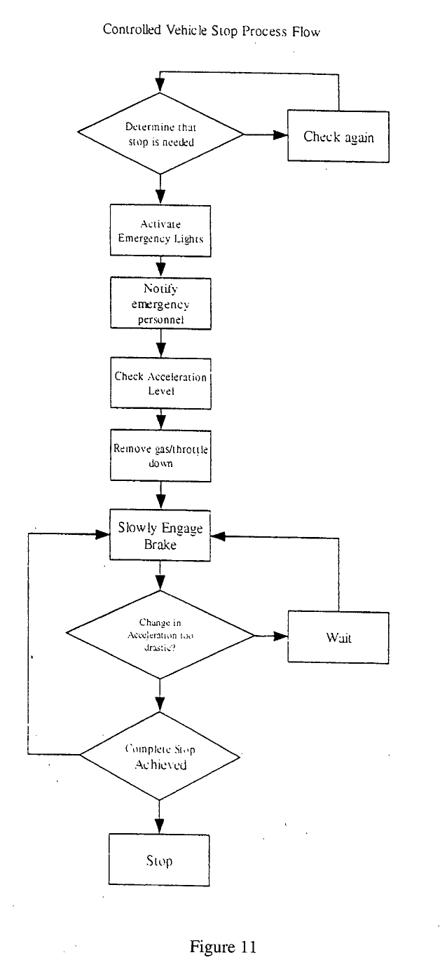

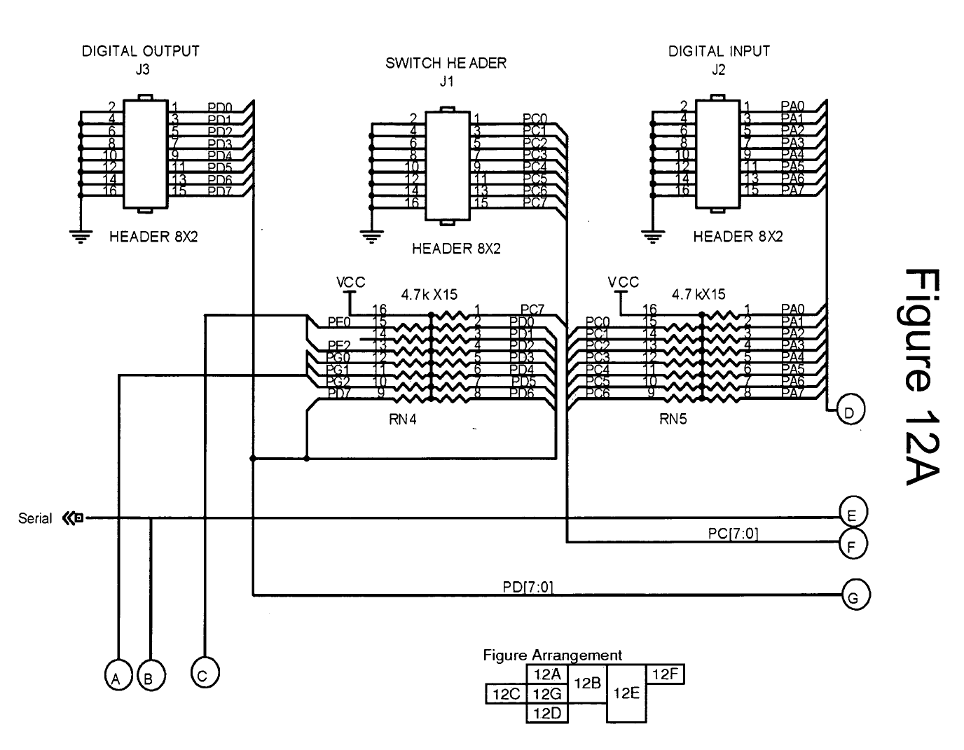

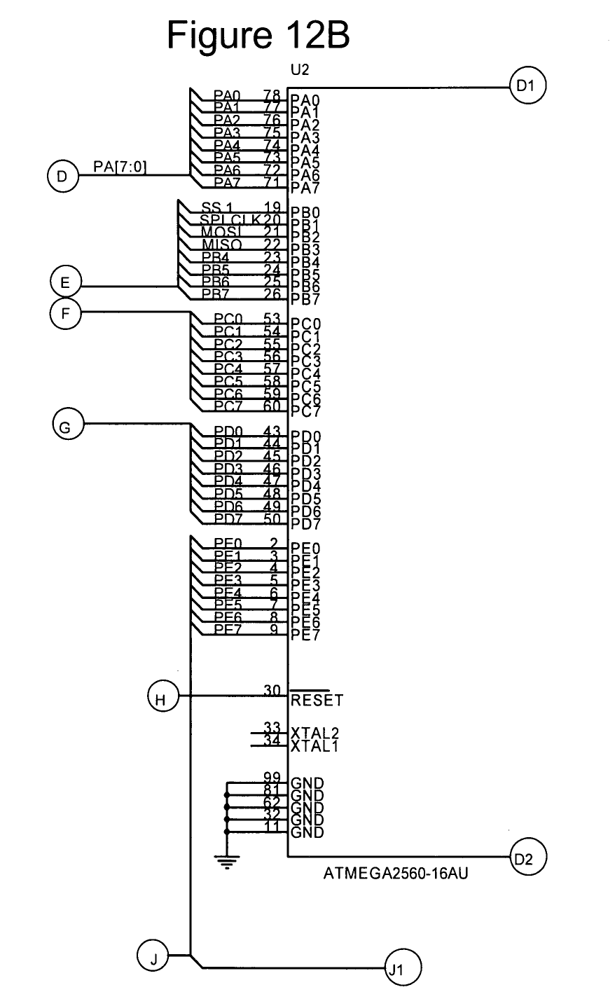

FIG. 11 depicts a top-level schematic of the software processes involved in completing a controlled vehicle stop. The process involves evaluation of several factors, such as the acceleration level. Upon a determination by the control subsystem that a controlled stop is in order, the vehicle subsystem removes the throttle and slowly engages the break. Per FIG. 11, the vehicle control subsystem continues to apply the breaks until the vehicle comes to a complete stop.

Other methods for implementing a controlled vehicle stop are contemplated, depending on the technology already in the vehicle. Many newer vehicles have computer controlled systems that may be accessed either through an on-board diagnostic interface bus or directly through the vehicle's controller area network (CAN). Another method comprises directly controlling the application of the accelerator pedal, depending on the type of linkage and newer systems that use “drive-by-wire” technology.

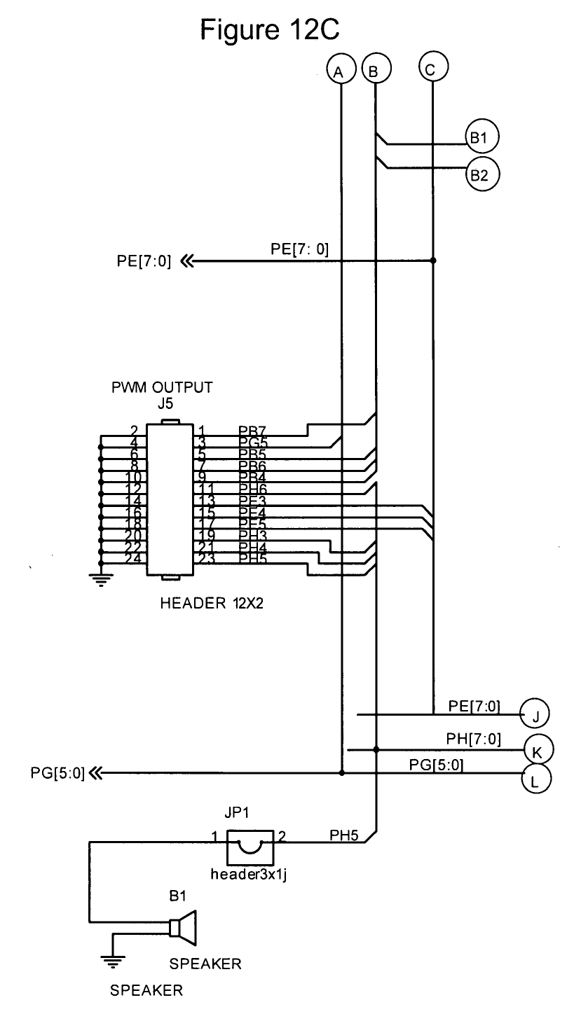

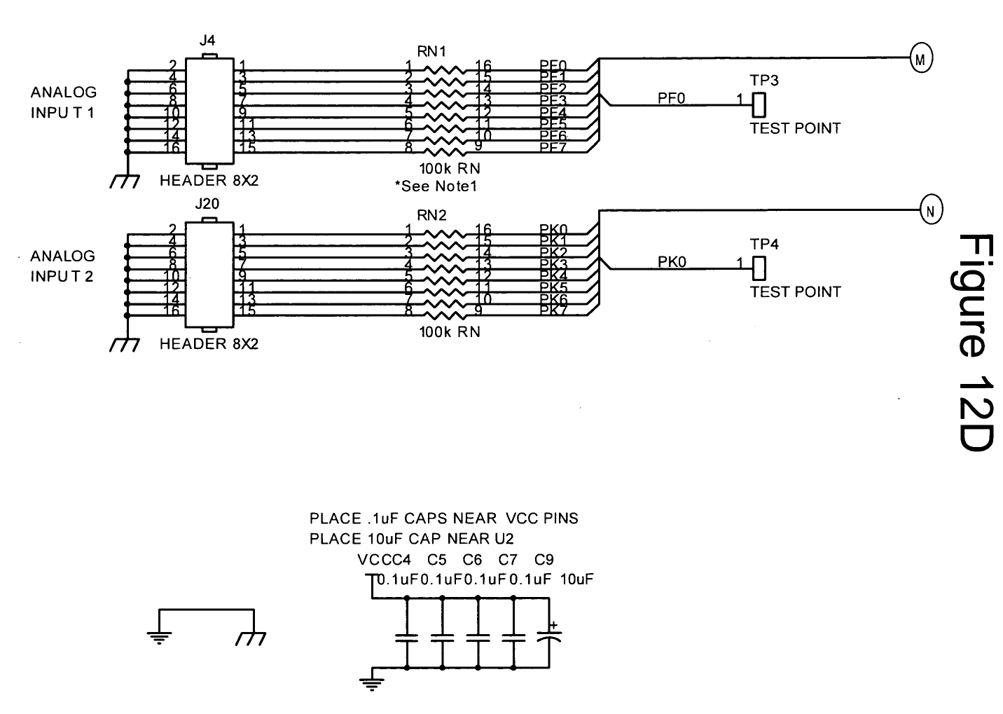

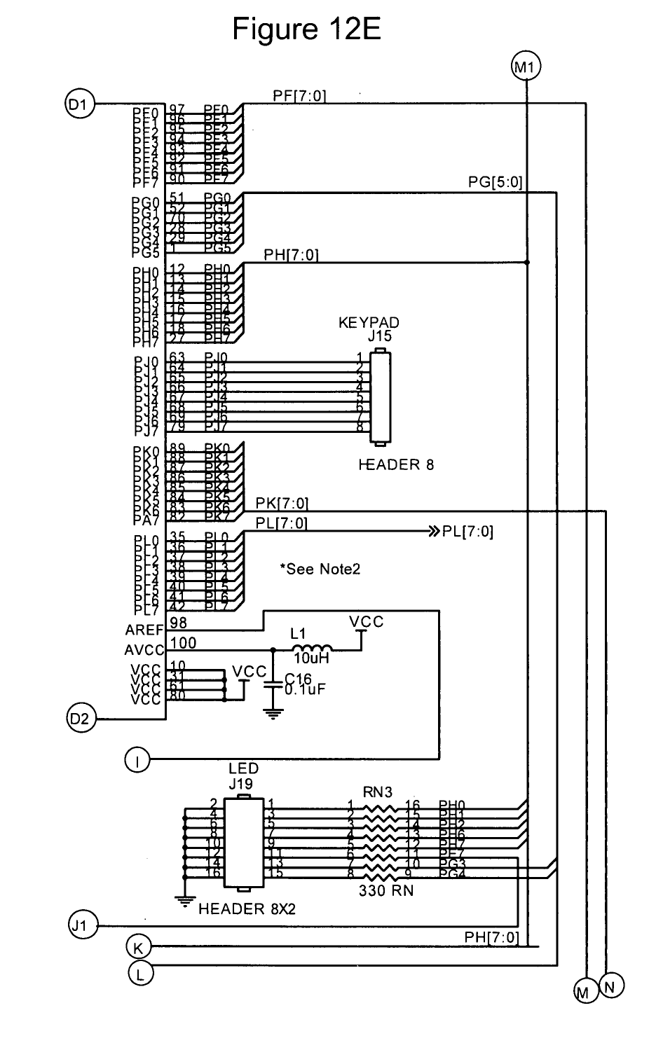

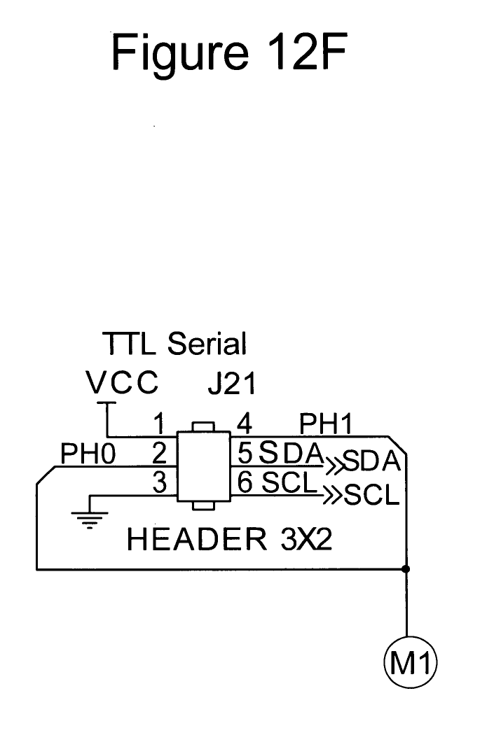

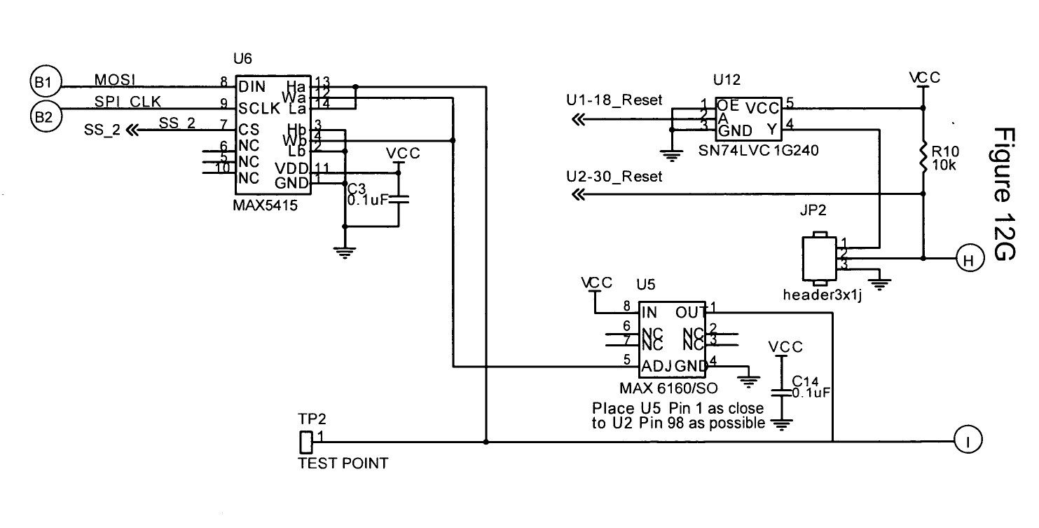

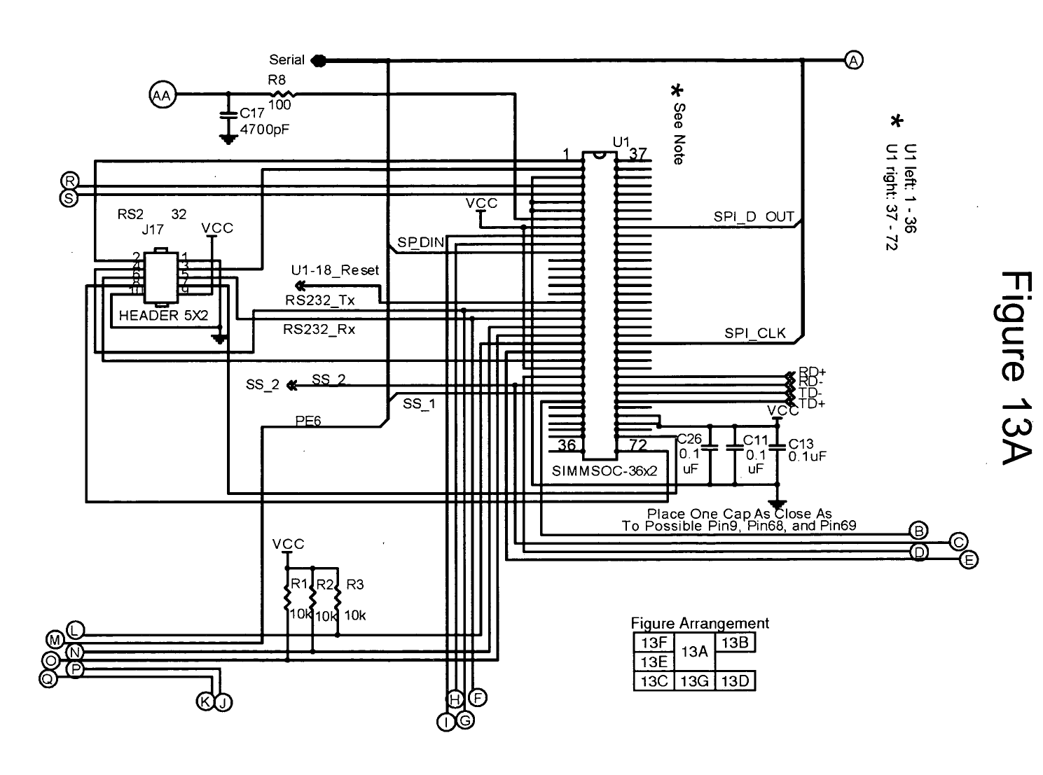

FIG. 12 is a schematic showing the details of the input/output expansion capabilities of the production tracker and how these interface to the microcontroller found within the production tracker. The design disclosed by FIG. 12 accommodates a wide variety of I/O allowed for including a variable output, as well as both digital and analog inputs and multiple low speed serial busses.

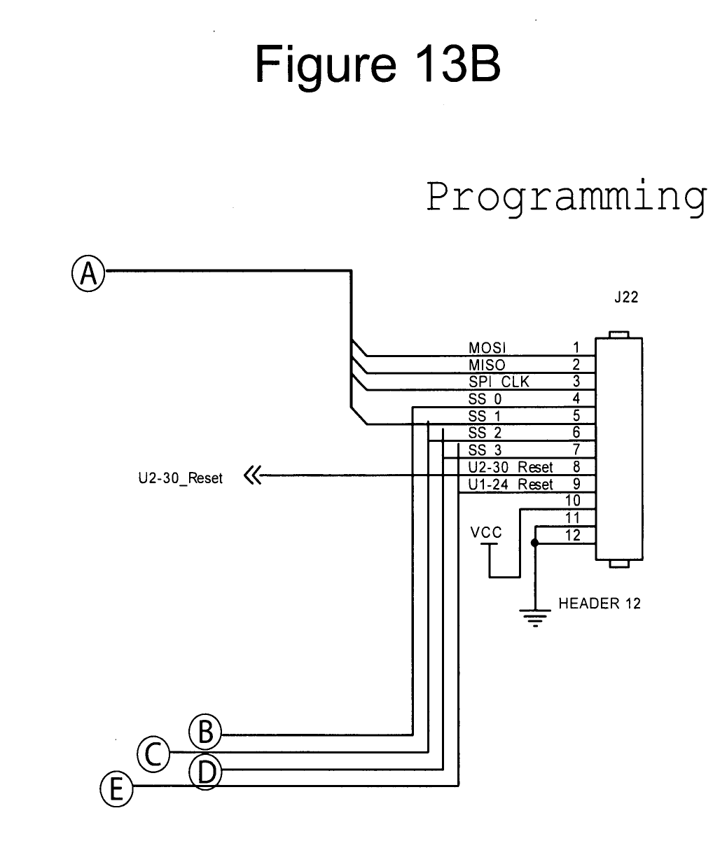

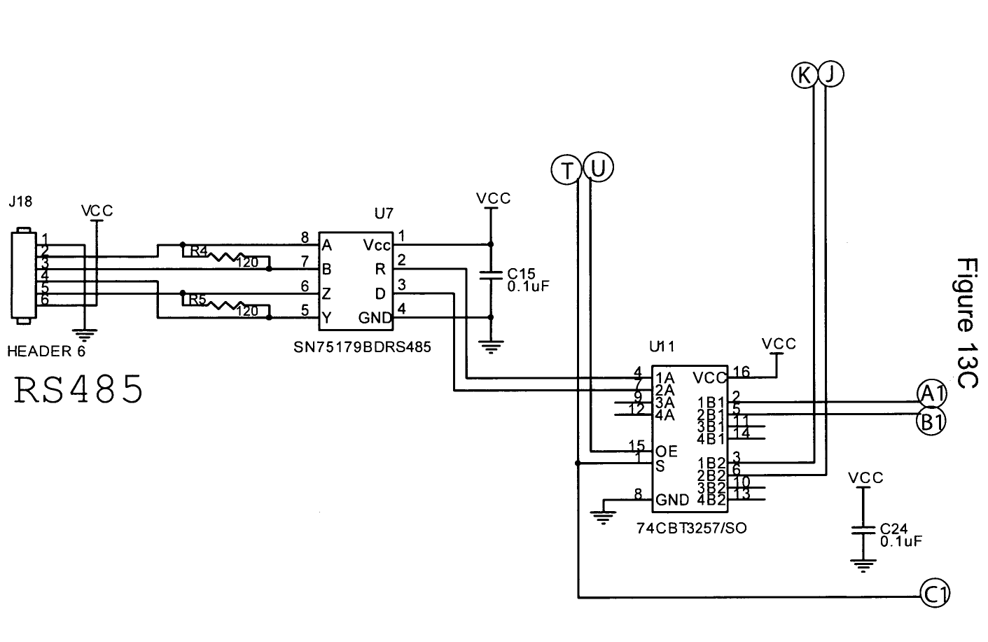

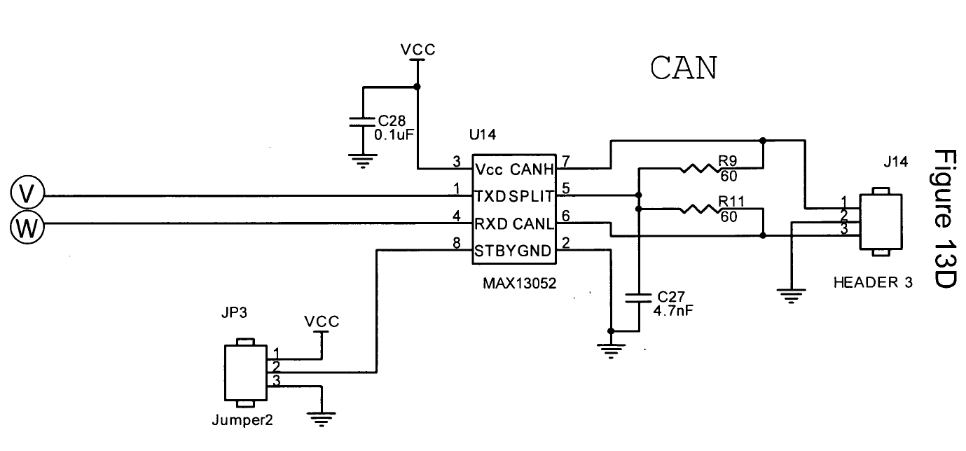

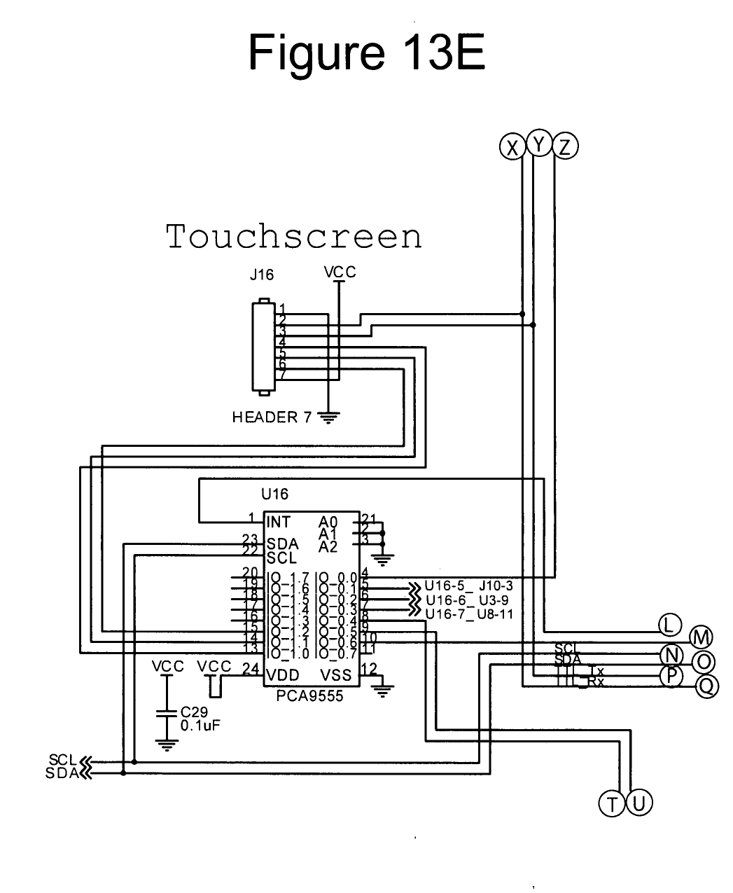

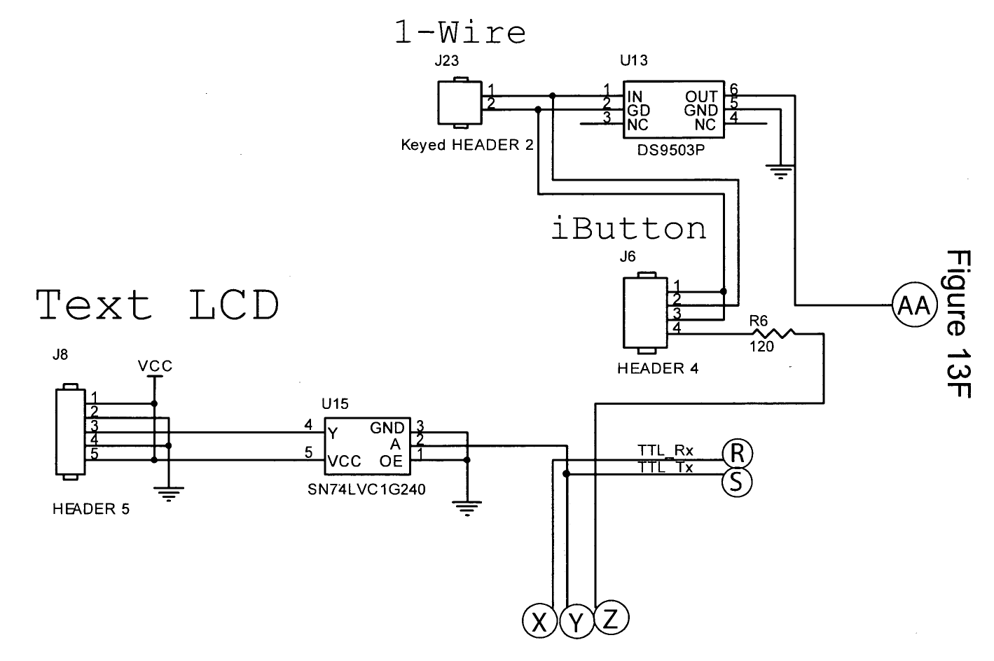

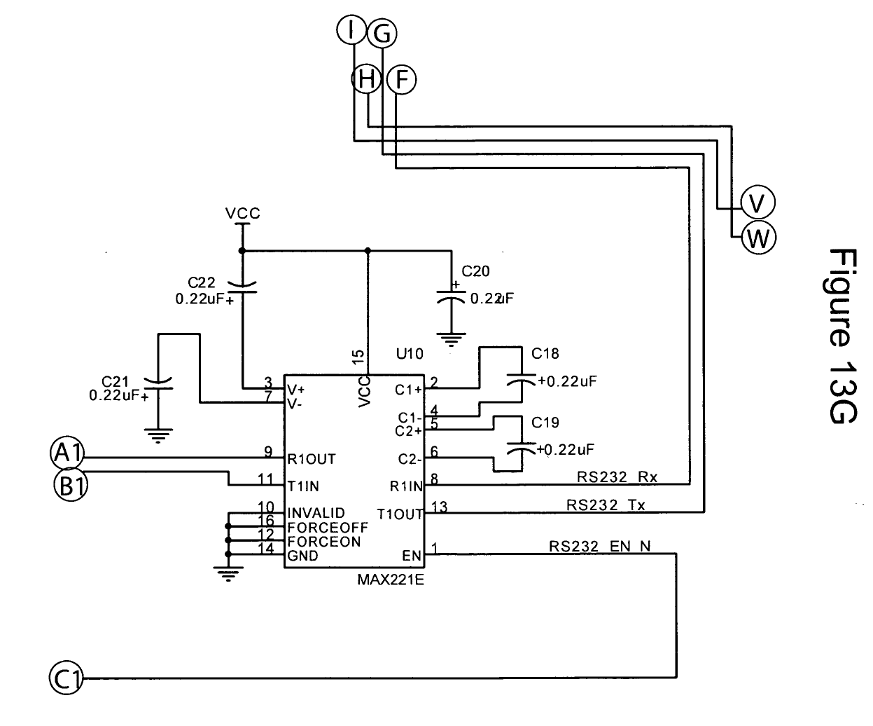

FIG. 13 is a schematic representation of the microcontroller area of the production tracker circuit. This circuitry is used for the primary production tracker circuit.

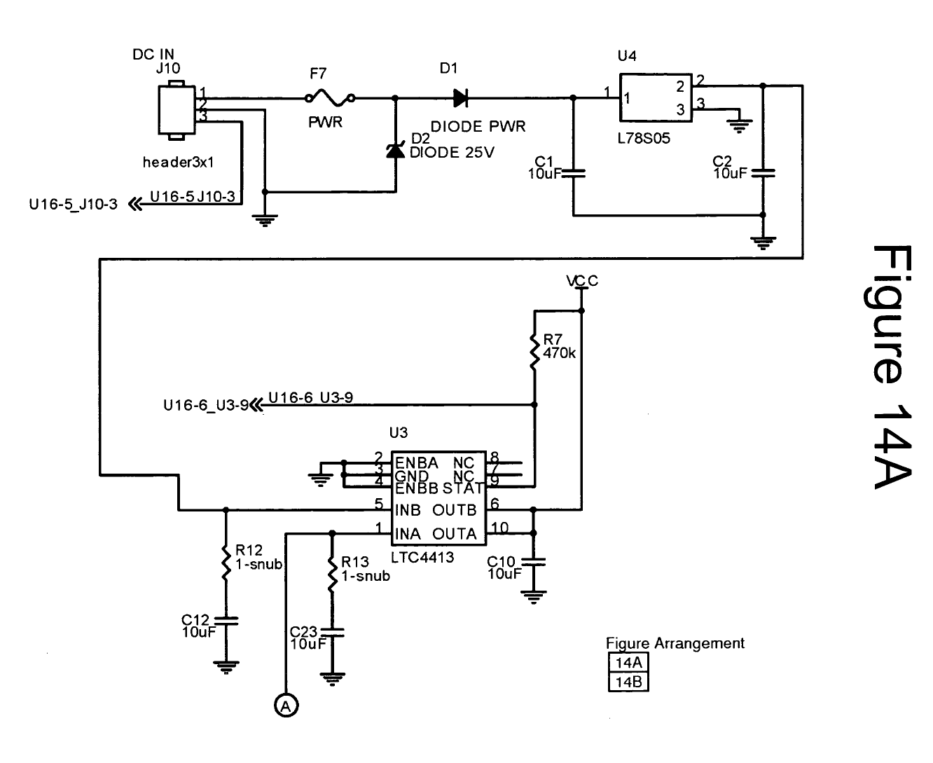

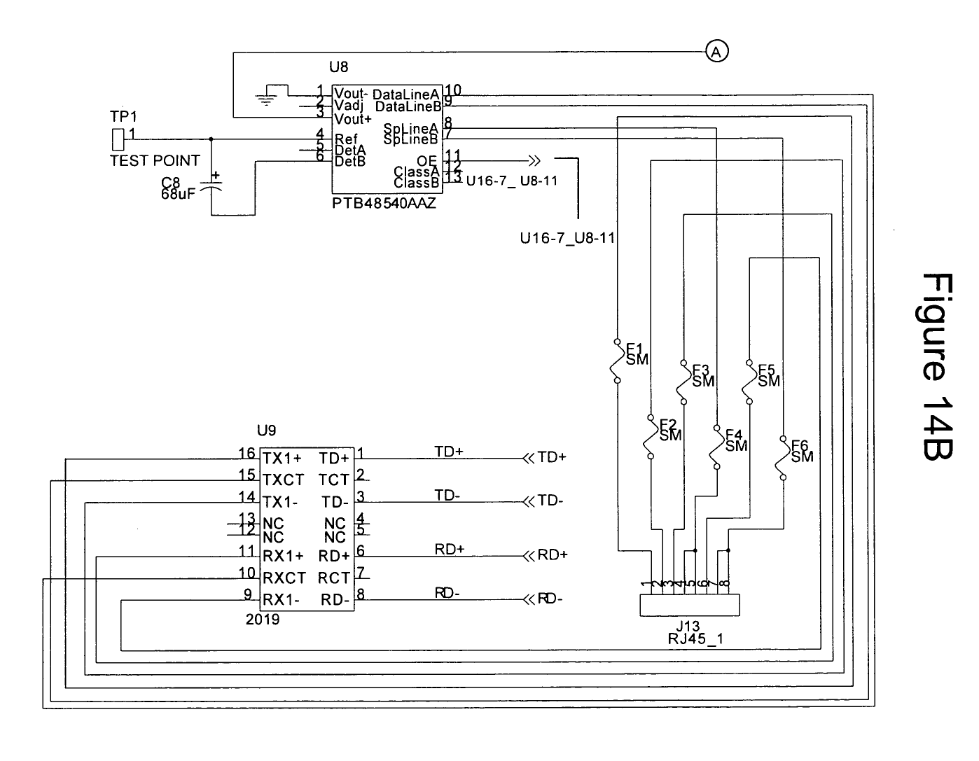

FIG. 14 is a schematic showing the details of the power supply section of the production tracker circuitry. The device can be powered through the Ethernet cable using Power over Ethernet.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A real-time management and monitoring system for a vehicle, the system comprising:
a. a vehicle subsystem, comprising a plurality of sensors to monitor environments in and around the vehicle;
b. a control subsystem for manipulating the vehicle based on input from said vehicle subsystem, and communicating with at least said vehicle subsystem;
c. a dispatch subsystem communicating with at least said control subsystem, said dispatch subsystem relaying data from said vehicle subsystem and said control subsystem to a remote database;
d. a maintenance subsystem communicating with at least said control system, said maintenance subsystem troubleshooting said control and dispatch subsystems; and
e. a rider subsystem communicating with at least said control system; said rider subsystem receiving control input from an operator.

2. The system as recited in claim 1 wherein said vehicle subsystem comprises:
a. a production tracking device; said production tracking device providing instant feedback to the operator of said vehicle;
b. a global positioning system device; said positioning device communicating to said vehicle subsystem the present position of the vehicle;
c. a rain gauge device; said rain gauge device communicating to said vehicle subsystem the amount of precipitation in the environment outside the vehicle;
d. a steering wheel sensor device; said steering wheel sensor device communicating to said vehicle subsystem steering wheel telemetry information;
e. at least one camera; said camera communicating with said vehicle subsystem images of the environments;
f. at least one display; said display communicating vehicle subsystem status to vehicle operator; and
g. an engine diagnostic system; said engine diagnostic system communicating engine use data to said vehicle subsystem.

3. The system as recited in claim 2 wherein said control subsystem communicates wirelessly with said vehicle subsystem.

4. The system as recited in claim 2 wherein the steering wheel sensor device comprises an add-on layer for pre-existing steering wheel in a pre-existing vehicle.

5. The system as recited in claim 2 wherein the steering wheel sensor device divides the steering wheel into discreet sections of equal size.

6. The system as recited in claim 2 wherein the steering wheel sensor device detects the number of hands concurrently present on the steering wheel.

7. The system as recited in claim 1 wherein the vehicle subsystem uses heuristic methods to determine whether a vehicle hijack is being attempted based on the number of hands that have come in contact with the vehicle steering wheel as conveyed to the vehicle subsystem by a steering wheel sensor.

8. The system as recited in claim 1 wherein the vehicle subsystem uses fuzzy logic to determine whether the vehicle operator has lost consciousness based on the force of operator physical interactions or contacts and the number of operator contact points with the steering wheel as indicated by a steering wheel sensor to the vehicle subsystem.

9. The system as recited in claim 1 wherein the vehicle subsystem provides the dispatch subsystem a live video of the vehicle upon detection of possible hijack or incapacity of the driver.

10. The system as recited in claim 1 wherein the vehicle subsystem provides the vehicle operator an opportunity to respond via the production tracking device upon determination by vehicle subsystem that a hijack is attempted or that operator has become incapacitated.

11. The system as recited in claim 9 wherein the vehicle subsystem executes an orderly stop of the vehicle upon detection of incapacity of vehicle operator.

12. The system as recited in claim 9 wherein the vehicle subsystem notifies the dispatch subsystem upon detection of incapacity of vehicle operator.

13. The system as recited in claim 1 wherein the vehicle is a school bus with a retracting stop arm indicator.

14. The system as recited in claim 12 wherein the school bus camera continuously records traffic passing by the school bus.

15. The system as recited in claim 12 wherein the school bus camera is adjusted to photograph drivers who fail to stop despite the extension of the stop arm indicator.

16. The system as recited in claim 12 wherein the vehicle subsystem adjusts the angle of the camera so that the camera recording encompasses the largest amount of the neighboring traffic as possible by determining the number of lanes found on the road where the bus is traveling.

17. The system as recited in claim 15 wherein the vehicle subsystem determines the number of lanes found on the road by locating the school bus on a map conveyed to the vehicle subsystem by the control subsystem and through the use of the global positioning device.

18. The system as recited in claim 12 wherein the vehicle subsystem notifies the control subsystem upon detection of motion in the school bus during time periods when no key is in ignition of the school bus.

19. The system as recited in claim 1 wherein the rider subsystem notifies the control system when rider subsystem receives information on demand for vehicle stops.

20. The system as recited in claim 1 wherein the dispatch subsystem schedules a replacement vehicle upon receipt of signal from control subsystem that a vehicle or vehicle operator are otherwise incapacitated.
